(19) United States
(12) Patent Application Publication
(10) Pub. No.: US 2010/0060550 A1
(43) Pub. Date: Mar. 11, 2010

(54) System and Apparatus for Linked Display Devices

(76) Inventors: Matt McGinn, Chicago, IL (US); Chuck Linebaugh, Chicago, IL (US)

Correspondence Address: SABRE TECHNICAL SERVICES CORP., 4917 N. DAMEN AVE., CHICAGO, IL, 60625, US

(21) Appl. No.: 12/555,288

(22) Filed: Sep. 8, 2009

Related U.S. Application Data
(60) Provisional application No. 61/095,277, filed on Sep. 8, 2008.

(51) Int. Cl. G09G 5/00

(52) U.S. Cl. 345/2.1

(57) ABSTRACT

A system, display device and computer program product for controlling and coordinating a display device displaying information and other material in areas where foot traffic can be present. The system, display device, and computer program can display information, data, and images received from a network where the information, data and images are relevant to the area. The system, display device, and computer program product can coordinate displayed information and other material between multiple display devices.

The invention is a system and a display device for displaying information and other material in areas where foot traffic can be present, for example, in areas near people-movers such as escalators.

The system comprises an information exchange system for exchanging information, entertainment, and status data between a remote monitoring station and at least one display device. The system can exchange information and data between the monitoring station and the display device over a network for the purpose of coordinating visual displays and audible display 40s projected by the display device. The system can display advertising, public service information, entertainment, news, maps and various other material.

Here and throughout, “display” is defined as including both visual and audible messages and information that are broadcast by the device to a surrounding area. Here and throughout, “people-mover” will be used to represent people-moving equipment of various types and styles including, but not limited to, escalators and moving sidewalks.

The system can process information provided by the remote monitoring station, the display device, from the network, from public broadcast data, and from various other information sources. The system can react to conditions local to one or more display devices and can cause visual displays and audible display 40s related to the conditions to be displayed at one or more display devices. For example, the system can process information indicating increased traffic at a particular display device and cause visual displays and audible display 40s at display devices near to the particular display device. Similarly, the system can process public safety announcements from the network and cause visual displays and audible display 40s relating to public safety procedures. The system can comprise more than one display device, can process information from more than one network, and can relay information taken from more than one public broadcast source.

The system enables communication between a display device and a monitoring station, between two display devices, between a display device and a network, and between a monitoring station and a network.

The display device of the current invention is especially effective in public areas where foot traffic is present. The display device can be configured for indoor use and can be configured for outdoor use. The display device can comprise a visual display and an audible display 40. The display device can display advertising, public service information, entertainment, news, maps and various other material. The display device can be configured for placement at the entrance and at the exit of people-moving equipment such as escalators and moving sidewalks, though the display device is useful in many other locations. The display device is especially useful for venues with heavy foot traffic and venues attracting large crowds, including but not limited to, airports and train stations, sports arenas, music and theater venues, shopping malls, government buildings, and various other venues. The display device can be positioned between adjacent people-movers.

The display device can be placed near to people-movers so that the display is exposed to passers-by. The display device can be positioned proximal a people-mover handrail so that the display is clearly within view of passers-by but does not impede entering and exiting the people-mover.

The display device can display material stored in a storage unit within the display device. The display device can receive material for display from a network, where the network can comprise a local area network (LAN), the Internet, an ethernet, a wide area network (WAN), a metropolitan area network (MAN), a public safety network, and various other telecommunications networks.

The display device can receive instructions from the network to display specific material stored on the storage unit, and to display various effects from the device. The display device can transmit information to the network. The transmitted information can comprise device status information, information gathered from sensors, and various other information and effects.

### FIGURES

FIG. 1 is a view of an embodiment of the display device positioned near an escalator.

FIG. 2 is a view of another embodiment of the display device positioned near an escalator.

FIG. 3 is a view of the embodiment of FIG. 1.

FIG. 4 is a view of the embodiment of FIG. 2.

FIG. 5 is a cutaway view of an embodiment of the display device.

FIG. 6 is a side view of an embodiment of the display device.

FIG. 7 is a cutaway view of an embodiment of the display device.

FIG. 8 is a schematic depiction of the system.

FIG. 9 is a schematic depiction of an administrator.

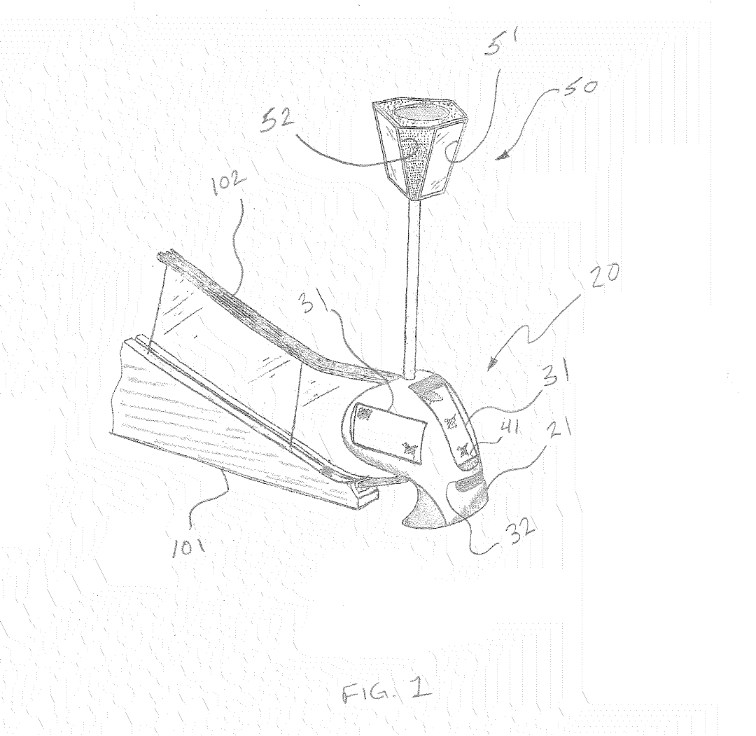

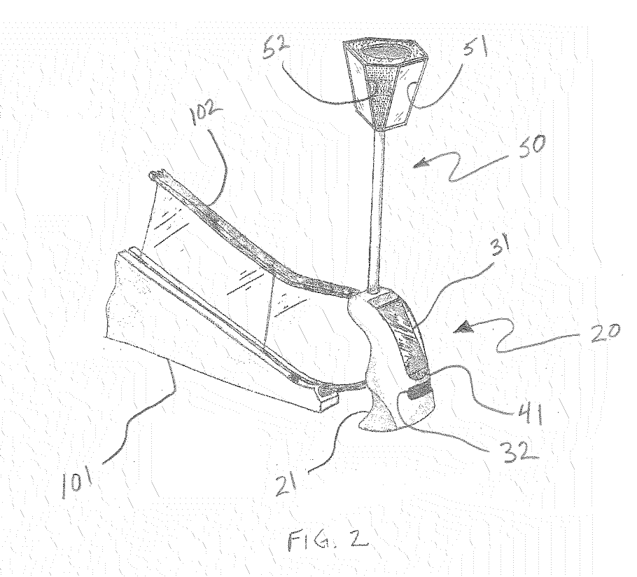

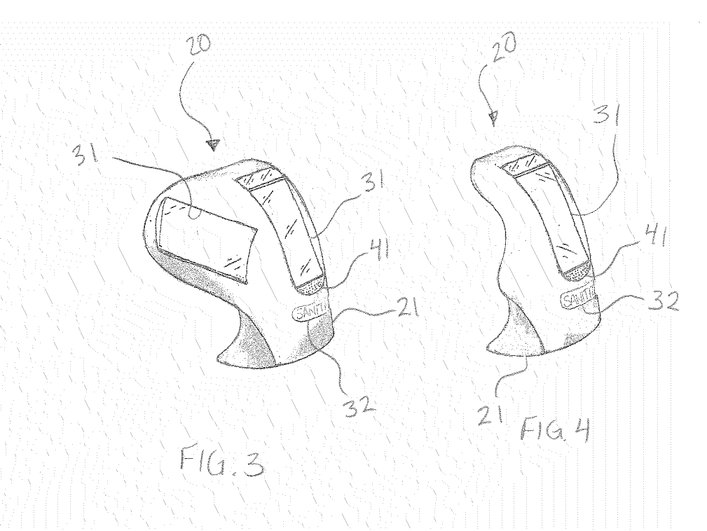

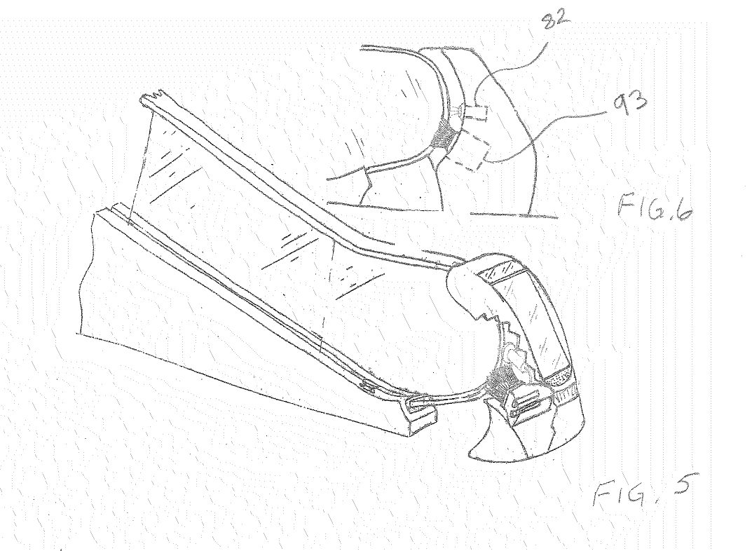

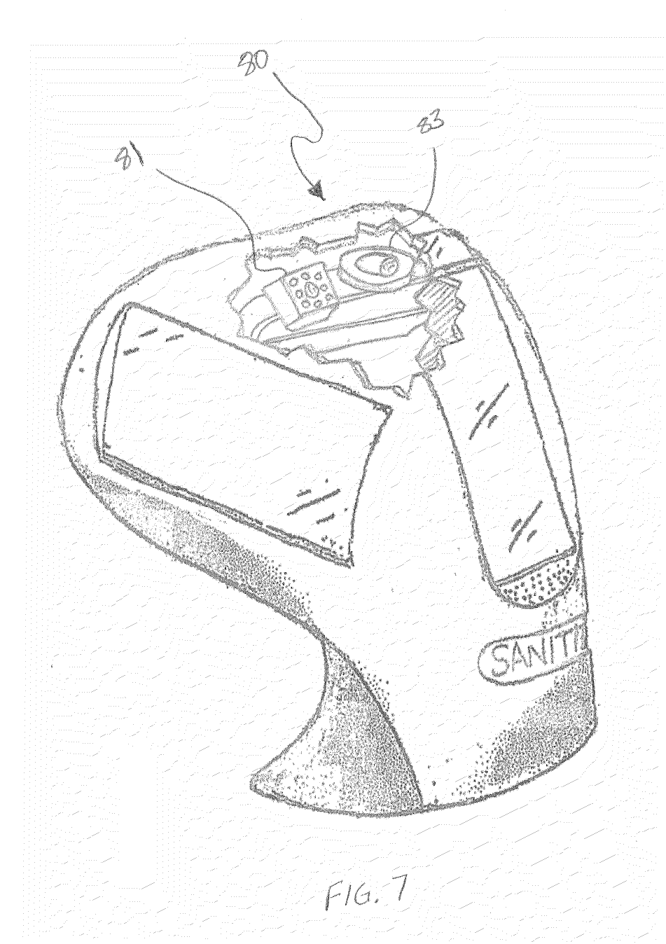

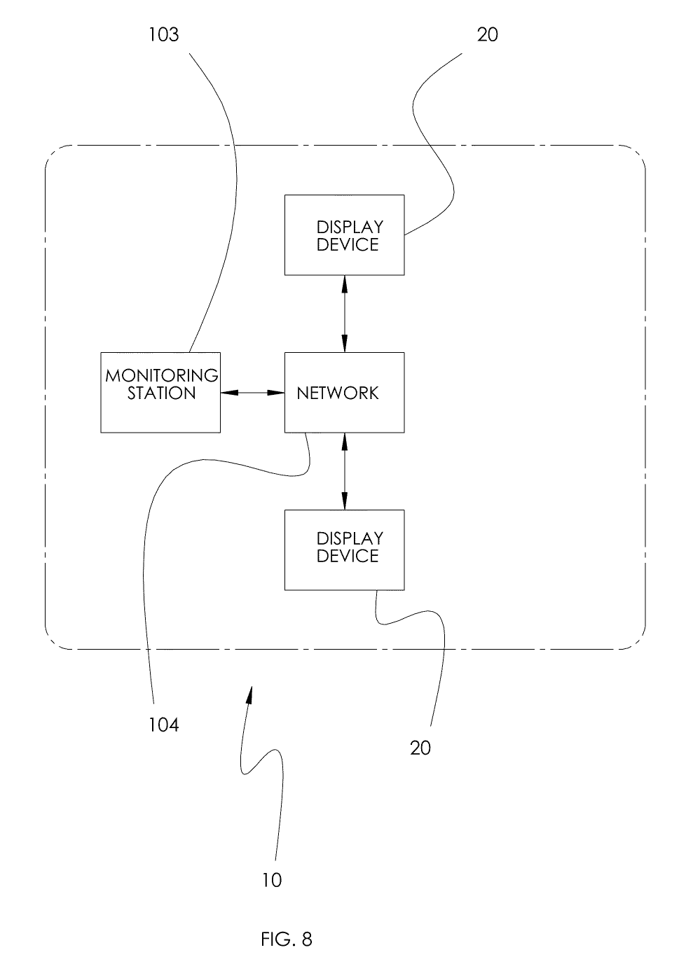

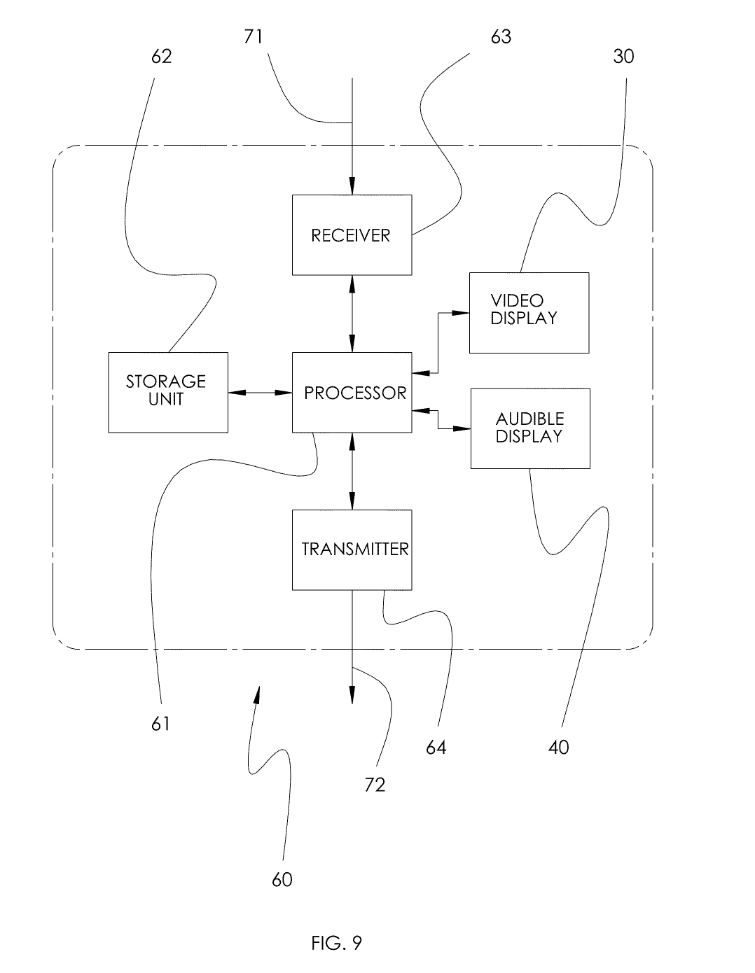

The display device 20 can comprise a base 21 connected to a ground level surface proximal a people-mover. The base 21 can be fixedly connected to the ground level surface and can be repositionably connected to the ground level surface. The base 21 can be configured to conform to a contour of a people-mover handrail 102. Alternatively, the base 21 can be configured to wrap around a people-mover handrail 102. The base 21 can interact with the handrail 102 in various ways.

The display device 20 can comprise a tower 50 extending upwards from the base 21. The tower 50 can be utilized to enhance visibility of visual displays and to enhance audibility of audible display 40.

The display device 20 can comprise at least one video display 30 mounted to the base 21 for displaying visual images to passers-by.

The visual display 30 can be mounted to the base 21 facing oncoming passers-by. Alternatively, the visual display 30 can be mounted at an angle to oncoming passers-by. The display device 20 can comprise multiple visual displays mounted to the base 21. The visual display 30 can be mounted to the tower 50.

The visual display 30 can comprise a video screen 31. The video screen 31 can be one of various types of screens including, but not limited to, LCD screens, LED screen, projection screens, plasma screens, and combinations thereof. The video screen 31 can be overlaid by an anti-glare screen and by a substantially transparent protective screen to prevent damage to the video screen 31.

The visual display 30 can comprise a light 32, such as a flashing alarm light and a message light, mounted to the base and mounted to the tower. The light 32 can alert passers-by to the display device, can alert passers-by to the people-mover, can alert passers-by to a condition of the display device and to a condition of the people-mover, can alert passers-by to a general condition proximal the display device and the people-mover, and can alert passers-by to various other conditions.

The visual display 30 can comprise various other visual display elements and combinations thereof.

The display device 20 can comprise at least one audible display 40 mounted to the base 21 for displaying audible sounds to passers-by.

The audible display 40 can be mounted to the base 21 facing oncoming passers-by. Alternatively, the audible display 40 can be mounted towards the people-mover so as to broadcast to outgoing passers-by. Alternatively, the audible display 40 can be mounted to broadcast at an angle to the passers-by. The audible display 40 can be mounted to the tower 50.

The audible display 40 can comprise an audio speaker 41. The audible display 40 can comprise an audible alarm. The audible display 40 can comprise various audible display elements and combinations thereof that are capable of emitting sounds.

The device 20 can comprise an administrator 60. The administrator 60 can control and coordinate the visual display 30 and audible display 40. The administrator 60 can cause the device 20 to display various visual and audible information and effects. The administrator 60 can search a network 104 and retrieve data and various information from the network 104 and can cause the device 20 to display the retrieved data and information.

The administrator 60 can comprise a storage unit 62 for storing information for visual display and for audible display. The storage unit 62 can store data and instructions for use by the administrator 60 in coordinating, storing, and causing the visual display and the audible display.

The administrator 60 can comprise a receiver 63 for receiving an input signal 71 from a network 104. The receiver 63 can be a wireless receiver and can receive signals over wires, optical paths, sound paths and various other signal pathways.

The input signal 71 can comprise information for visual display and for audible display. The input signal 71 can comprise data and instructions for use by the administrator 60 in coordinating, storing, and causing the visual display and the audible display.

The administrator 60 can comprise a processor 61. The processor 61 can read data and instructions from the storage unit 62 and process the data and instructions to control visual display and to control audible display. The processor 61 can access the receiver 63 for the input signal 71 and process the data and instructions comprising the input signal 71, and process the data and instructions to control visual display and to control audible display.

The administrator 60 can comprise a transmitter 64 for transmitting an output signal 72 to the network 104. The transmitter 64 can be a wireless transmitter and can transmit signals over wires, optical paths, sound paths and various other signal pathways.

The administrator 60 can comprise a transceiver for receiving the input signal 71 and for transmitting the output signal 72.

The output signal 72 can comprise information for visual display and for audible display. The output signal 72 can comprise data and instructions for use by the network 104 in coordinating, storing, and causing the visual display and the audible display. The output signal 72 can comprise device status information, information gathered from sensors, and various other information and effects.

The display device can comprise a sensor 80 for monitoring conditions proximal the display device. The sensor 80 can sense conditions and provide data and information on conditions to the administrator via an input signal.

The sensor 80 can comprise a motion detector 81 for detecting motion proximal the display device. When the motion detector 81 detects motion, the administrator can cause the visual display 30 and the audible display 40 to broadcast appropriate information to passers-by. When no motion is detected, the administrator can cease broadcasting.

The sensor 80 can comprise a gaze detector 83 for detecting eye contact with passers-by. When the gaze detector 83 detects eye contact, the administrator can cause the visual display 30 and the audible display 40 to broadcast appropriate information to passers-by. When no eye contact is detected, the administrator can cease broadcasting. The gaze detector 83 can record incidents of eye contact when specific video displays and specific audible display are being broadcast. Recorded incidents can be used to affect subsequent video displays and subsequent audible display.

The sensor 80 can comprise a video camera 84 for viewing the area proximal the display devices. The sensor 80 can provide real-time video to the administrator for transmitting to the network 104 and to a monitoring station 103, via the network 104. The real-time video can be shared with other display devices and with various other locations, such as a public safety network. Based on the real-time video, the administrator can cause the visual display 30 and the audible display 40 to broadcast appropriate information to passers-by.

The sensor 80 can comprise a handrail direction detector 82 for detecting the direction of handrail travel. Based on the detected handrail direction, the administrator can cause the visual display 30 and the audible display 40 to broadcast appropriate information to passers-by.

The display device can comprise a handrail cleaner 93, for example an ultraviolet sanitizer, an anti-bacterial applicator, and a cleaning brush. The handrail cleaner 93 can interact with the visual display 30 to broadcast a “Sanitizing” message and to broadcast various appropriate messages via a light or a video screen.

1. A display device product comprising:
a base connected to a ground level surface, the base wrapping around at least a portion of a people-mover handrail;
a tower extending upwards from the base, the tower comprising a plurality of visual displays and at least one audio display;
a plurality of sensors including:
a gaze detector;
a video camera;
a motion sensor;
a handrail direction sensor;
a plurality of emitters including:
a scent dispenser;
a UV cleaner;
a UV curtain;
a handrail brush;
an administrator for controlling and coordinating the plurality of visual displays, the at least one audio display, the plurality of sensors, and the plurality of emitters;
the administrator comprising:
a receiver for receiving an input signal from a network;
a transmitter for transmitting an output signal to a network;
a data storage unit for storing information, instructions and images;
a processor, the processor in use accessing data from the data storage unit, from the receiver, and from the transmitter; and
the processor processing data and instructions to facilitate controlling and coordinating the plurality of visual displays, the at least one audio display, the plurality of sensors, and the plurality of emitters.

2. A display device control system, the system comprising:
a plurality of display devices, each display device from the plurality of display devices comprising:
a base connected to a ground level surface, the base wrapping around at least a portion of a people-mover handrail;
a tower extending upwards from the base, the tower comprising a plurality of visual displays and at least one audio display;
an administrator for controlling and coordinating the plurality of display devices;
the administrator comprising:
a receiver for receiving an input signal from a network;
the input signal comprising data, information, and instructions for controlling and coordinating the plurality of display devices;
a transmitter for transmitting an output signal to a network;
the output signal comprising data, information, and instructions for controlling and coordinating the plurality of display devices;
a data storage unit for storing information, instructions and images;
a processor, the processor in use accessing data from the data storage unit, the input signal from the receiver, and the output signal from the transmitter; and
the processor processing data and instructions to facilitate controlling and coordinating the plurality of visual displays, the at least one audio display, the plurality of sensors, and the plurality of emitters.

3. A computer program product comprising:
at least one computer-readable medium comprising computer-executable program code embodied therein, the program code when executed providing plurality of program code modules, the modules comprising:
a display device administrator module;
an input signal receiving module;
an output signal transmitting module;
a data storage module;
an instruction processing module;
where the input signal receiving module receives an input signal from a network, the input signal comprising data, information, and instructions for controlling and coordinating a plurality of display devices;
each display device from the plurality of display devices comprising:
a base connected to a ground level surface, the base wrapping around at least a portion of a people-mover handrail;
a tower extending upwards from the base, the tower comprising a plurality of visual displays and at least one audio display;
a plurality of sensors including:
a gaze detector;
a video camera;
a motion sensor;
a handrail direction sensor;
a plurality of emitters including:
a scent dispenser;
a UV cleaner;
a UV curtain;
a handrail brush;
the output signal comprising data, information, and instructions for controlling and coordinating the plurality of display devices;
the data storage module storing information, data, and instructions;
the instruction processing module processing data and instructions to facilitate controlling and coordinating the plurality of display devices; and
the display device administrator module controlling and coordinating the plurality of display devices via the input signal receiving module, the output signal transmitting module, the data storage module, and the instruction processing module.
